(19) United States
(12) Patent Application Publication
(10) Pub. No.: US 2014/0122191 A1
(43) Pub. Date: May 1, 2014

(54) ENCOURAGING SHOPPING ASSISTANCE BY CHILDREN USING DIGITAL SHOPPING LISTS

(71) Applicant: Wal-Mart Stores, Inc., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/665,918

(22) Filed: Oct. 31, 2012

(51) Int. Cl. G06Q 30/06

(52) U.S. Cl. CPC G06Q 30/0633
USPC 705/14.1

(57) ABSTRACT

Systems and methods are disclosed for encouraging participation of children in a shopping trip. A parent assigns a number of items or specific items of a shopping list to a child and the assignment is transmitted to a child's device. A child's selection of a reward item is received from the child's device. An interface on the child's device enables check off of the items as the child retrieves them. Upon completion of the assignment, a parent may authorize check off of the reward item and this authorization may be transmitted to the child device. Check off of the reward item may then be enabled on the child device.

### BACKGROUND

1. Field of the Invention

This invention relates to managing an electronic shopping list and, more particularly, to managing a shopping list or partially shared among multiple users.

2. Background of the Invention

Shopping with children can be unpleasant for both parents and children. The parent must locate all the items on a shopping list while keeping children entertained and out of trouble. Children that become impatient and upset can be disruptive and cause a parent embarrassment and distress. Often times children that can be distracted or given a task to perform will behave better thereby reducing stress for all involved, but a busy parent often doesn't have time to devise games or activities while shopping.

The systems and methods disclosed herein provide novel approaches for encouraging the participation of children in a shopping trip in order make shopping a less stressful experience for parents and more enjoyable for children and more time efficient by dividing up tasks that can be performed in parallel.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for involving children in shopping trip in accordance with an embodiment of the present invention;

FIG. 2 is a block diagram of a computing device suitable for implementing embodiments of the present invention;

FIGS. 3A and 3B are diagrams of interfaces for enabling participation of children in a shopping trip in accordance with an embodiment of the present invention;

FIG. 4 is a process flow diagram of a method for setting up involvement of a child in a shopping trip in accordance with an embodiment of the present invention;

FIG. 5 is a process flow diagram of a method for interacting with a child during a shopping trip in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

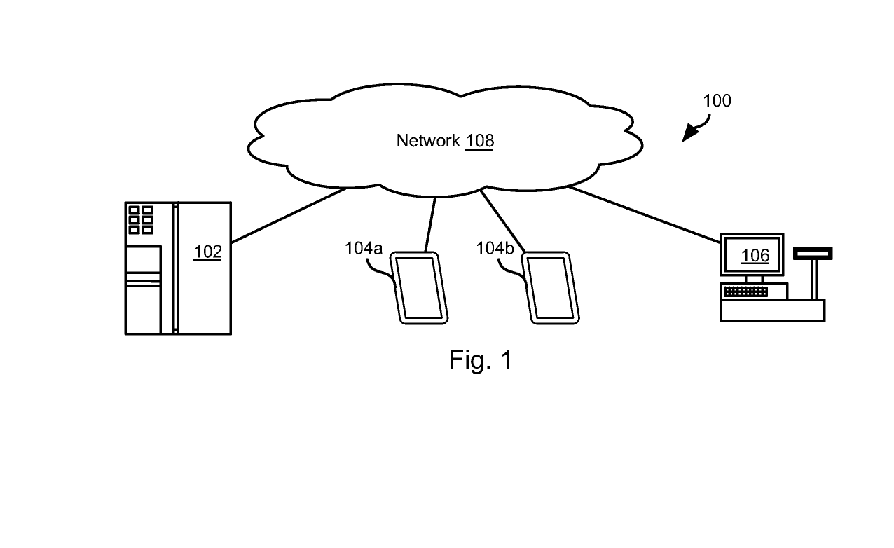

FIG. 1 illustrates a system 100 in which methods described hereinbelow may be implemented. The system 100 may include a server system 102 that may be embodied as one or more server systems each including one or more processors that are in data communication with one another. The server system 102 may be in data communication with one or more user computers 104a, 104b and one or more point of sale (POS) devices 106. In the methods disclosed herein, the user computers 104a, 104b are advantageously mobile devices such as a mobile phone or tablet computer. As known in the art, many mobile phones and tablet computers also include cameras that can be used to scan optical codes such as barcodes, quick response (QR) codes, or textual information. In some embodiments, some or all of the methods disclosed herein may be performed using a desktop computer or any other computing device as the user computer 104a, 104b. For purposes of this disclosure, discussion of communication with a user or activity by the user may be interpreted as communication with a computer 104a, 104b associated with the user or activity taking place on a computer associated with the user. The POS 106 may be located within a store and may be part of a POS network. In some embodiments, a POS 106 may be operable to process online transactions. In some embodiments, separate computers of the server system 102 may handle communication with the user computers 104 and POS 106.

Some or all of the server 102, user devices 104a, 104b, and POS 106 may communicate with one another by means of a Network 108. The network 108 may be embodied as a peer-to-peer wireless connection between devices, a connection through a local area network (LAN), WiFi network, the Internet, or any other communication medium or system.

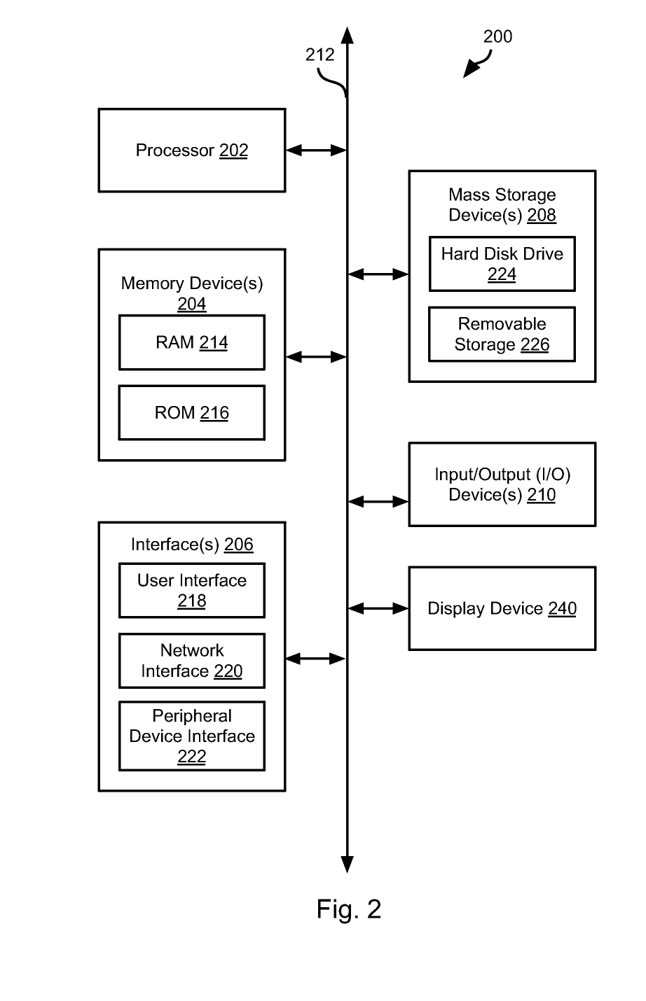

FIG. 2 is a block diagram illustrating an example computing device 200. Computing device 200 may be used to perform various procedures, such as those discussed herein. A server system 102, user computer 104a, 104b, and POS 106 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

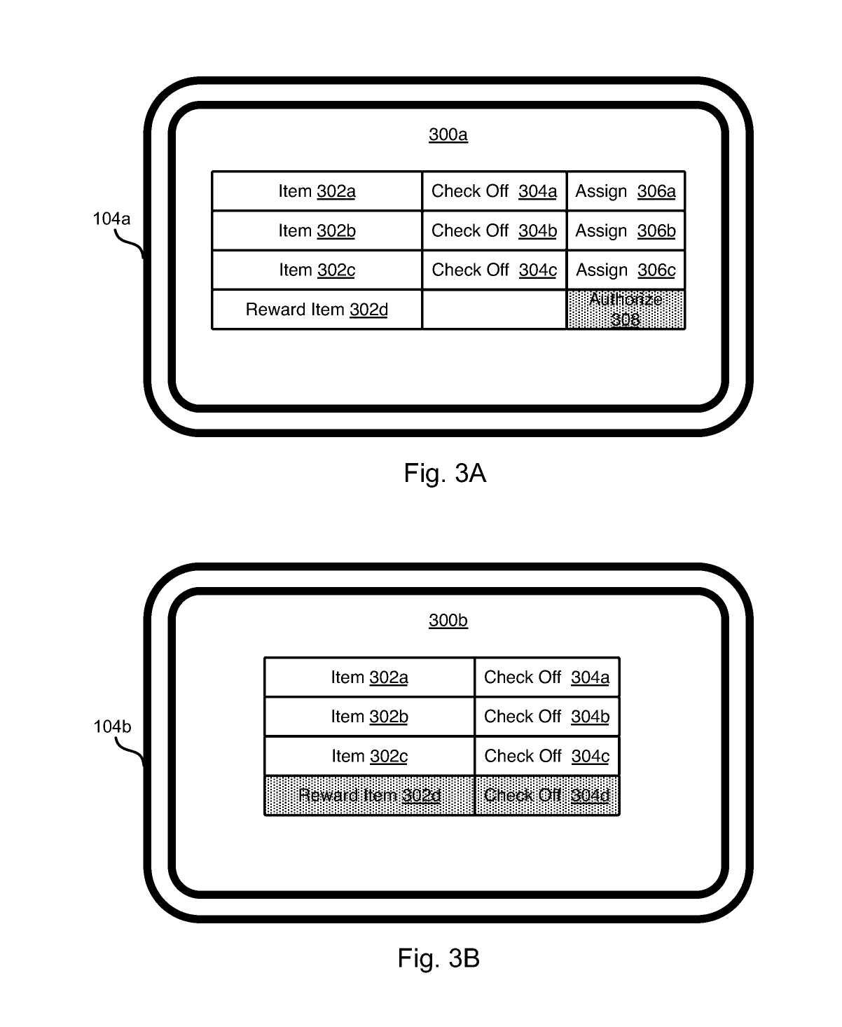

FIGS. 3A and 3B illustrate interfaces for a parent and child that may be displayed on user computing devices 104a, 104b during a shopping trip. For purposes of the following discussion a user computing device 104a represents a parent (or other guardian) computing device and the user computing device 104b represents a child computing device. A link between the parent computing device 104a and the child computing device 104b may be established by logging in to a remote account as a child and parent, respectively, form the respective devices. A link may also be established by entering a common code into the devices 104a, 104b in order to establish a common shopping trip. A link may also be established by performing a simultaneous action on both devices 104a, 104b that may be used by a server 102 to identify devices that are to be linked. For example, the devices 104a, 104b may include accelerometers. Accordingly, the users of the devices 104a, 104b may invoke a shopping application for implementing the methods disclosed herein and then perform a common movement simultaneously, such as bumping the devices 104a, 104b together or shaking them simultaneously. Various other methods for linking devices may also be disclosed. Also, for purposes of this disclosure, the methods described herein as being performed by the computing devices 104a, 104b may be performed on one of the computing devices 104a, 104b and receive interaction from the other of the computing devices 104a, 104b and display information by means of an interface presented on the other of the computing devices 104a, 104b. In yet another alternative embodiment, the functionality of the methods described below may be provided by the server system 102 with interaction received by the server system 102 from the computing devices 104a, 104b and information from the server system 102 displayed on the computing devices 104a, 104b by means of an interface provided on the user devices 104a, 104b.

Referring specifically to FIG. 3A, a parent computing device 104a may display an interface 300a. The interface 300a may include a graphical representation of a shopping list including a plurality of items 302a-302c. The interface 300a may additionally include check off user interface elements 304a-304c that enable a user to mark an item as having been added to a shopping cart or otherwise no longer requiring retrieval. The interface 300a may further include assignment user interface elements 306a-306c. The assignment elements 306a-306c may enable a user to assign items in the shopping list to another user, such as a child associated with the child computing device 104b. In some embodiments, the 300a may enable an assignment in terms of a number of items that the child must retrieve. A parent may also assign a time or time period in which retrieval of the assigned items must occur to receive a reward.

As will be described in greater detail below, a child may add a reward item 302d to the shopping list. The parent may authorize the child to check off the reward item 302d only after the child has retrieved items assigned to the child. Accordingly, the reward item 302d may include an authorization interface element 308 that may be tapped or otherwise selected by the parent to authorize check off of the reward item by the child. As shown in FIG. 300a, the authorization element 308 may be disabled (e.g. grayed out) until a child has checked off items assigned to the child. Thereafter, the authorization element 308 may be enabled and the parent may be permitted to interact with the authorization element 308 and authorize the child to check off the reward item, e.g. pick up the reward item and place it into a cart, basket, bag, or simply carry the reward item to the cash register.

Referring specifically to FIG. 3B, the interface 300b for a child computing device 104a may likewise include a shopping list of items 302a-302c and interface elements 304a-304c enabling the child to check off the items 302a-302c as they are retrieved. The items 302a-302c of the interface 302b may include only those items that have been assigned to the child. The interface 300b may additionally include a reward item 302d that was selected by the child. The check off interface element 304d corresponding to the reward item 302d may be disabled until the items 302a-302c assigned to the child have been checked off and checking off of the reward item 302d has been authorized by the parent. The check off element 304d may be visually represented as disabled (e.g. greyed out) until checking off of the reward item is enabled.

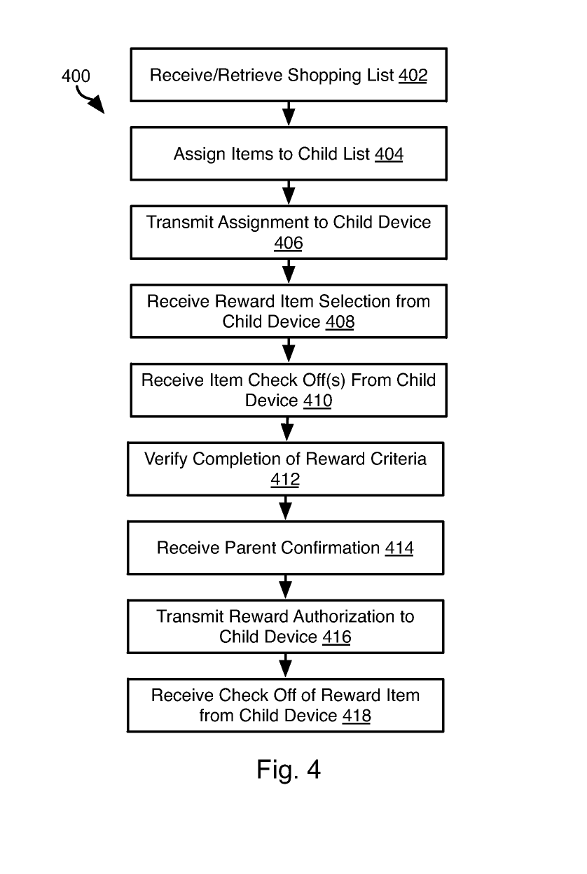

FIG. 4 illustrates a method 400 that may be implemented using a parent computing device 104a and the parent interface 300a. As already noted, all or part of the method 400 may be implemented by the parent computing device 104a. Alternatively, some or all of the method 400 may be implemented by a server system 102 with interaction managed through the interface 300a on the parent computing device 104a.

The method 400 may include receiving or retrieving 402 a shopping list. The shopping list may be received by the parent selecting items from a product catalog hosted by the server system 102 and navigated by means of a browser or other interface provided on the parent computing device 104a. In some embodiments, a shopping list may be associated with an account hosted by the server system 102 or some other entity, such that the shopping list may be retrieved 402 from this account. The shopping list may also be received 402 by the parent manually typing the items of the list into the shopping list.

The method 400 may include assigning 404 items of the shopping list to a child. For example, as illustrated in FIG. 3A, this may include receiving a selection of an item or interface element of the item indicating an intent to assign the item on the parent computing device 104a. Assigning 404 items of the shopping list may include receiving a number from the parent without the specification of specific items. The items selected for assignment may be transmitted 406 to the child device 104b for display on the child device 104b.

To encourage participation of a child, the child may be prompted to select a reward item. The reward item selected by the child may therefore be transmitted from the child computing device 104b and received 408 by the parent computing device 104a. In some embodiments, the parent may disapprove or approve of a selected reward item on the parent computing device 104a. In the case where a reward item is disapproved, disapproval of the selected item may be transmitted to the child device 104a and the child may be prompted on the child computing device 104b to select a new reward item. The reward item may be selected by the child by means of scanning a barcode, a text search, a voice search, selection from a precompiled list of popular rewards or any other means.

During a shopping trip, the child may check off items assigned to the child on the child computing device 104b. Accordingly, the items checked off by the child may be transmitted to the parent device 104a and received 410 by the parent computing device 104a. The parent computing device 104a may verify 412 completion of reward criteria. For example, where the assignment was to retrieve a certain number of items, the parent computing device 104a may verify 412 a count of the number items for which check offs were received from a child. Where an assignment is an assignment of specific items, verifying 412 may include verifying that check offs were received for the specific items. Where the reward criteria includes a time limit for completing either of these criteria (a number of items, specific items, or both) verifying 412 may include verifying 412 that check offs of the items were received within the time limit.

In some embodiments, competition may be encouraged by associating a plurality of child devices 104b with a parent device 104a. Each child device 104b may be assigned 404 an assignment that is transmitted 406 to each child device 104b. Accordingly, in such embodiments, the reward criteria may include being the first to complete one's assignment, or being one of the first N to complete one's assignment. Accordingly, in such embodiments, verifying 412 completion of reward criteria may include verifying that a child was in fact the first, or one of the first N, to transmit check offs of assigned items. In some embodiments, different reward items may be associated with a child's place in completing an assignment (1^{st}, 2^{nd}, 3^{rd}, etc.). Accordingly, the authorization for the reward item transmitted as described below may indicate which of the items are authorized for a child according to the child's place.

The parent device 104b may receive 414 confirmation that the child has in fact retrieved all of the items that were checked off. This may be accomplished by the parent clicking the authorization element 308 of the interface 300a.

Upon receiving verification of completion of the child's assigned items, an authorization to check off the reward may be transmitted 416 from the parent computing device 104a to the child computing device 104b. Once the child has retrieved the reward item, the child may check off the reward item on the child computing device 104a. A notification of check off of the reward item may then be transmitted from the child computing device 104a and received 418 by the parent computing device 104b.

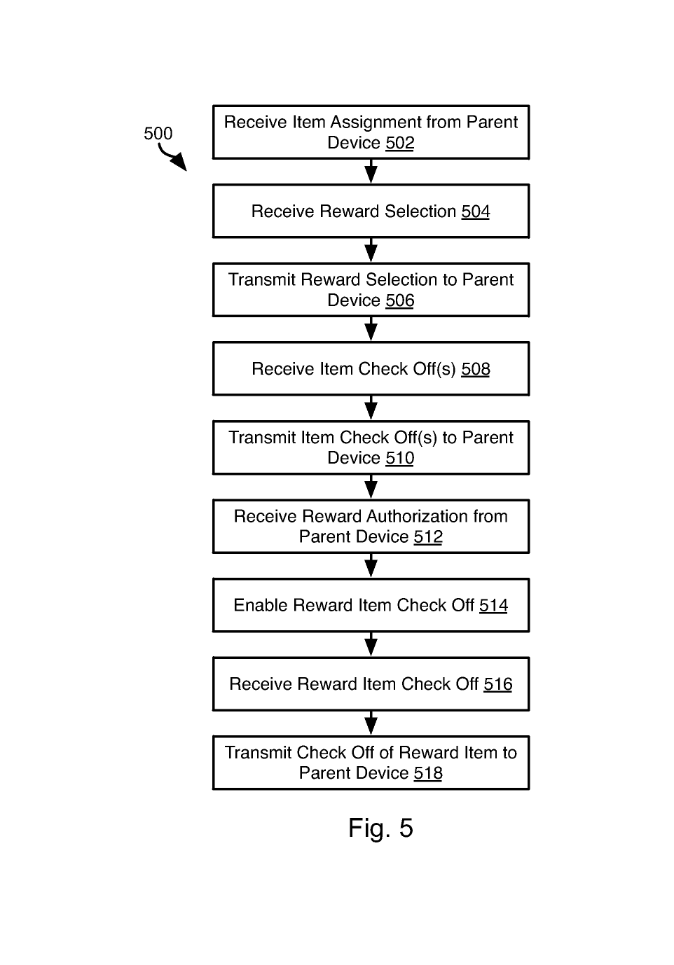

FIG. 5 illustrates an example method 500 that may be executed by a child computing device 104a. As already noted, actions attributed to the child computing device 104a may be performed on the parent computing device 104a or server system 102 with information displayed and interaction received in the performance of these steps on the child computing device 104a.

The method 500 may include receiving 502 an assignment of items from the parent computing device 104a by the child computing device 104b. In some embodiments, an assignment may simply be a number of items that are required to receive a reward, rather than specific items. In some embodiments, an assignment may indicate a time interval or time period in which check off of the assigned items must be received in order for the child to receive the reward item.

The child computing device 104a may receive 504 the selection of a reward item by the child. A reward item may be received by receiving a selection of the reward item from a product catalog navigated on the child computing device 104a. A reward item may also be received by detecting scanning of a barcode or other optical code affixed to a product using a camera of the parent computing device 104a. The reward item may also be received 504 by receiving a typed identifier or by some other means.

The reward item selected may be transmitted 506 from the child computing device 104b to the parent computing device 104a. An interface, such as the illustrated interface 300b, may be provided to receive 508, by the child computing device 104b, check offs of assigned items by the child. The items checked off may be transmitted 510 to the parent computing device 104a.

When all of the assigned items have been checked off and the parent has authorized, on the parent computing device 104a, check off of the reward item, authorization of check off of the reward item may be received 512 from the parent device 104a. In response, the child computing device 104a may enable 514 check off of the reward item. This may include altering a visual representation of the reward item on the interface 300b, such as removing greying-out text or altering the color of the reward item. The child may then check off the reward item as it is retrieved from a store display. This check off may be received 516 and notification of check off of the reward item may be transmitted 518 to the parent device 104a.

Various other approaches may be used to encourage participation in a shopping trip. For example, points may be accumulated for items retrieved and checked off by the child. The amount of points may be determined partially on the timing of the retrieval, e.g. how fast the child retrieves assigned items. The number of points assigned may be proportional to the number of items checked off by the child. In some embodiments, the parent is prompted to authorize check off of the reward item when the child's point total achieves a threshold value. Although the methods described herein are described as interactions between a parent and a child, the methods described herein could be performed in the context of any other relationship such as spouses, roommates, friends, or the like.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for encouraging shopping involvement, the method comprising:
receiving, by a first mobile computing device, a shopping list;
receiving, by the first mobile computing device, a reward item selection from a second mobile computing device;
evaluating, by the first mobile computing device, whether check-offs of a first group of items on the shopping list has been received from the second mobile computing device; and
authorizing, by the first mobile computing device, check-off of the reward item selection on the second mobile computing device only if check-offs of the first group of items are received from the second mobile computing device.

2. The method of claim 1, further comprising receiving, by the first mobile computing device, an assignment of the first group of items to a user associated with the second mobile computing device prior.

3. The method of claim 1, further comprising receiving, through a graphical user interface on the first mobile computing device, check-offs of items in the shopping list other than the first group of items.

4. The method of claim 3, further comprising receiving, by the first mobile computing device, check-offs of items in the shopping list other than the first group of items by scanning optical codes using a camera of the first mobile computing device.

5. The method of claim 1, further comprising authorizing, by the first mobile computing device, check-off of the reward item selection on the second mobile computing device only if check-offs of the first group of items are received from the second mobile computing device within a time interval.

6. The method of claim 1, wherein receiving, by the first mobile computing device, the shopping list comprises receiving selections from an electronic product catalog.

7. The method of claim 1, wherein the first mobile computing device is a mobile phone.

8. The method of claim 1, further comprising establishing an association between the first mobile computing device and the second mobile computing device.

9. A method for encouraging shopping involvement, the method comprising:
receiving, by a first mobile computing device, an assignment of a first group of items from a shopping list from a second mobile computing device;
receiving, on an interface of the first mobile computing device, a selection of a reward item;
receiving, on the interface of the first mobile computing device, check-offs of the first group of items;
receiving, by the first mobile computing device from a second mobile computing device, authorization to check-off the reward item selection on the second mobile computing device only after check-offs of the first group of items are received.

10. The method of claim 9, further comprising transmitting notice of the check-offs of the first group of items to the second mobile computing device.

11. The method of claim 9, further comprising enabling an interface element for checking off the reward item upon receiving authorization to check-off the reward item.

12. The method of claim 11, further comprising receiving check-off of the reward item upon enabling of the interface element.

13. The method of claim 11, wherein the interface element for checking off the reward item is an image of the reward item.

14. The method of claim 12, further comprising transmitting notice of check-off of the reward item to the second mobile computing device.

15. The method of claim 9, wherein receiving, on the interface of the first mobile computing device, check-offs of the first group of items further comprises detecting scanning of optical codes corresponding to the first group of items by a camera of the first mobile computing device.

16. The method of claim 9, wherein the first mobile computing device is a mobile phone.

17. A method for encouraging shopping involvement, the method comprising:
receiving, by a computer system, an instruction from a first mobile computing device to transmit at least a portion of a shopping list to a second mobile computing device;
transmitting, by the computer system, the at least a portion of the shopping list to a second mobile computing device;
receiving, by the computer system, a reward item selection from the second mobile computing device;
receiving, by the computer system, check-offs of items of the at least a portion of the shopping list from the second mobile computing device;
transmitting, by the computer system, notification of the check-offs of items of the at least a portion of the shopping list to the first mobile computing device;
receiving, by the computer system, authorization of check-off of the reward item from the first mobile computing device; and
transmitting, by the computer system, authorization of check-off of the reward item to the second mobile computing device.

18. The method of claim 17, wherein transmitting at least a portion of the shopping list to the second mobile computing device further comprises:
receiving an assignment of a first group of items from the shopping list from the first mobile computing device; and
transmitting notification of assignment of the first group of items to the second mobile computing device.

19. The method of claim 17, wherein receiving the shopping list from the first mobile computing device comprises receiving selections from a product catalog.

20. The method of claim 17, wherein the first and second mobile computing devices are mobile phones.

21. The method of claim 17, further comprising:
receiving check-off of the reward item from the second mobile computing device; and
transmitting notification of check-off of the reward item to the first mobile computing device.
